(19) United States
(12) Patent Application Publication
(10) Pub. No.: US 2016/0170565 A1
(43) Pub. Date: Jun. 16, 2016

(54) LIGHT GUIDE ASSEMBLY FOR OPTICAL TOUCH SENSING, AND METHOD FOR DETECTING A TOUCH

(71) Applicant: MULTI TOUCH OY, Helsinki (FI)

(72) Inventors: Tommi ILMONEN, Espoo (FI); Pekka ÄYRÄS, Helsinki (FI); Heikki HYVÄRINEN, Kuopio (FI); Marco VÄLIMÄKI, Tuusula (FI)

(21) Appl. No.: 14/904,318

(22) PCT Filed: Jul. 14, 2014
(86) PCT No.: PCT/FI2014/050574

§ 371 Date: Jan. 11, 2016

(30) Foreign Application Priority Data
Jul. 12, 2013 (FI) PCT/FI2013/050762

(51) Int. Cl. G06F 3/042; G02B 6/35; F21V 8/00

(52) U.S. Cl. CPC G06F 3/0428; G02B 6/005; G02B 6/3522

(57) ABSTRACT

A light guide assembly (2) for use in a touch sensitive area (3) of an optical touch sensing device (1) for touch screens is configured to receive light, to allow the light thereby received to propagate in the light guide assembly, and to deliver the light thereby propagated in the light guide assembly further out of the light guide assembly. The light guide assembly comprises a plurality of light guide stripes (4, 5) for controlling the propagation of light. The optical touch sensing device is configured to detect the presence of an external object (10) on the basis of changes in the light delivered further out of the light guide assembly due to interaction of the light with the external object. According to the invention, the light guide assembly comprises an interaction arrangement (8, 9) configured to define at least one restricted interaction area (11) within the touch sensitive area for interaction between the light and the external object, the interaction arrangement comprising a two-way coupling arrangement (8, 9; 12; 14; 15) configured to couple light out of the light guide assembly, out of one light guide stripe (4), and to couple a portion of the thereby out-coupled light, after reflection from the external object (10), back to the light guide assembly into a second light guide stripe (5).

### FIELD

The present invention relates to touch sensing devices for touch screens, in particular to optical touch sensing devices, more particularly to optical touch sensing devices relying on interaction of light propagating in/via a light guide assembly with an external touching object.

### BACKGROUND

User interfaces for different kinds of electrical apparatuses are nowadays more and more often realized by means of different types of touch screens, wherein a touch sensing device is superposed on or integrated in a display. In touch sensing devices, the user input is given by touching the touch sensitive area of the touch sensing device instead of operating conventional mechanical buttons, sliding bars, rollers, etc.

Conventionally, such touch sensing devices have been configured to rely on purely electronic operation. Most commonly, touch sensing devices are based on resistive or capacitive touch sensitive films, wherein a touch by a finger or some other pointer changes the resistivity of, or signal coupling between conductive elements of a sensitive film.

In various applications, however, optical touch sensing devices are preferred nowadays. In an optical touch sensing device, touches cause changes in optical signals or signal paths, instead of electric ones. In one known approach, a frame can be assembled over a display, the frame comprising one or more light sources producing a “light field” in the free air above the surface of the display. A touch disturbs this light field, which is detected by means of one or more cameras or light sensors located within the frame.

Instead of a light field in the free space, light can also be transmitted to propagate, e.g. via total internal reflections (TIR), in a planar light guide plate formed as a part of a touch screen. Typically, a plurality of light source elements are located at the periphery of the light guide plate, thus outside the actual touch sensitive center area of the light guide plate. The light propagating in the light guide plate interacts with the touching object in that a touch on the light guide plate changes the difference in the refractive indices between the light guide and the ambient, thereby changing the conditions for TIR, resulting in “leakage” of light energy out of the light guide. The decrease in the light intensity propagated through and finally received from the light guide is detected as an indication of a touch. Commercial products based on such “Frustrated Total Internal Reflection” (FTIR) are provided e.g. by FlatFrog Laboratories AB.

Instead of FTIR, the primary touch-sensitive mechanism used for touch detection can also be based on in-coupling of illumination light, initially coupled out of the light guide, back into the light guide as a result of reflection from a fingertip or some other pointer brought into sufficiently close proximity to the light guide. Thus, in this case, the interaction mechanism is reflection of the light from an external touching object. This approach is utilized e.g. in the solution disclosed in US 2010/0321339 A1. Various coupling elements can be used to implement said out-/in-coupling.

However, the prior art use of light guide plates has some challenges/limitations. For example, sufficient spatial resolution requires careful controlling of the propagation of light to/from specific locations of the touch sensitive area. This may require, for example, lenses or other optical means for controlling the directivity of the light emitting/receiving elements. Alternatively, or in addition to that, complex detection algorithms may be required.

As an alternative to solutions relying on interaction of the light with an external touching object such as a finger, some optical touch sensing devices have been reported wherein the touch detection is based on physical deformation of the structures wherein the light is transmitted to propagate in result of a touch. Said physical deformation makes part of the light energy to leak out of the intended path, so that the decrease in the received light energy can be considered as an indication of a touch. For example, an optical waveguide comprising a plurality of cores wherein the propagating light waves are limited to is disclosed in US 2010/0156848 A1. Deformation of the waveguide cores in response to a touch makes part of the light energy leak out of the waveguide cores. This kind of approach requires the overall structure of the touch sensing device to have carefully adjusted flexibility for allowing the required deformations.

To summarize, there is still need for further improved optical touch sensing devices.

### PURPOSE OF THE INVENTION

It is a purpose of the present invention to provide novel solutions for optical touch sensing devices where touch detection is based on interaction of light propagating in a light guide assembly with an external touching object.

### SUMMARY

The present invention is characterized by what is presented in claims 1, 5, 13, and 14.

According to a first aspect, the present invention is focused on a light guide assembly which can be used in a touch sensitive area of an optical touch sensing device for touch screens. A touch sensitive area of an optical touch sensing device means here the actual area on the touch detecting device surface, within which area the touches are to be detected. In this context, the concept of a “touch” has to be understood broadly to cover not only true touches with physical contact with the touch sensitive area but also the presence of an external “touching” object in a sufficiently close proximity to the touch sensitive area. By a touch screen is meant a touch-based user interface configuration comprising a display and a touch sensing device superposed on the display.

The light guide assembly is configured to receive light, to allow the light thereby received to propagate in the light guide assembly, and to deliver the light thereby propagated in the light guide assembly further out of the light guide assembly.

The light guide assembly is configured for use in an optical touch sensing device which is configured to detect the presence of an external object on the basis of changes in the light delivered further out of the light guide assembly due to interaction of the light with the external object. Thus, the basic operation principle of such touch sensing device is based on interaction of the light propagating via the light guide assembly with an external object. Typically, the interaction changes, i.e. increases or decreases, the energy or intensity of the light delivered further out of the light guide assembly. The interaction of light with the external object distinguishes the present invention e.g. from those devices where the touch detection is based on physical deformation of some light guiding structure.

The “external object” can be, for example, a finger of the user of the touch sensing device. It can also be some other pointer with specific optical properties, e.g. with some specific predetermined reflection performance.

Naturally, an entire, operable optical touch sensing device shall have also other parts and elements, such as illuminating sources, e.g. light emitting diodes LEDs or laser diodes, to generate the light to be received in the light guide assembly. Similarly, some means, e.g. photodiodes, are needed for sensing the light delivered further out of the light guide assembly. Finally, those sources and sensing means shall be powered and controlled. However, many of the core principles of the present invention relate to the light guide assembly, so this part of a complete touch sensing device is discussed in most detail in this document.

The light guide assembly comprises a plurality of light guide stripes for controlling the light propagation in the light guide assembly. In other words, instead of, or in addition to a possible single, uniform light guide plate, the light guide assembly to be located in the touch sensitive area of a touch sensing device comprises a plurality of separate light guide stripes for controlling the light propagation in the light guide assembly. By using a plurality of discrete light guide stripes, the propagation of light in the light guide assembly can be efficiently and accurately controlled. This opens great new possibilities for designing and manufacturing optical touch sensing devices. For example, more accurate spatial control of light propagation in the light guide assembly may allow use of simpler driving scheme of the illumination sources and/or simpler detection algorithms than in the case of only one continuous and uniform light guide plate.

In this document, a “light guide” refers to any light guiding structure configured to guide light within a restricted volume. Typical examples are single-mode and multi-mode optical fibers and waveguides/light guides. For example, a light guide stripe can be implemented as a narrow stripe of a material with a higher refractive index, surrounded by a cladding formed of another material with a lower refractive index. The propagation can be based e.g. on total internal reflections (TIR). Then, with sufficiently high incident angle of the light rays with respect to the surface normal of the stripe, the light experiences a total internal reflection at the interface between the two materials. Thus, the light continues propagation within the stripe instead of escaping it. The light guide materials and other details can be designed according to the principles known in the art; therefore no detailed explanation on them is given in this document.

According to the present invention, the light guide assembly comprises an interaction arrangement configured to define at least one restricted interaction area within the touch sensitive area for interaction between the light and the external object. By restricted interaction area is meant that outside this area a touch, or the presence in a close proximity, of an external object such as a finger does not substantially interact with the light, and thus does not substantially change the light finally delivered out of the light guide assembly. Thus, the spatial controllability of touch detection is further improved by the restricted interaction area. There can be a plurality of restricted interaction areas within the touch sensitive area. There can also be a plurality of interaction arrangements, each defining one or more restricted interaction areas.

The restricted interaction area can be defined by various structural means, depending also on the actual interaction mechanism for which the light guide assembly is configured. The interaction arrangement comprises a two-way coupling arrangement configured to couple light out of the light guide assembly and to couple a portion of the thereby out-coupled light, after reflection from the external object, back to the light guide assembly for detecting the presence of the external object on the basis of said reflection. In this approach, the restricted interaction area is defined via the size, structural configuration, and location of the coupling arrangement. The restricted interaction area corresponds to the portion of the touch sensitive area within which an external object shall lie in order to properly reflect the portion of the initially out-coupled light out so that it can be coupled back to the light guide assembly.

In the present invention, the “interaction” of light with an external object thus refers to reflection of the out-coupled light from the external object back to the light guide assembly.

With the operation principle based on reflection from the external object, no true contact of the external object on the touch sensing device is necessary; it is sufficient to have the external object in sufficiently close proximity to the touch sensitive area of the touch sensing device so that a sufficient portion of the initially out-coupled light is reflected back to the light guide assembly. Therefore, the term “touch” covers in this document also the presence of an external object in close proximity to the touch sensitive area.

The coupling arrangement is configured to couple light out of a first light guide stripe and to couple the portion of the thereby out-coupled light, after reflection from the external object, back to the light guide assembly into a second light guide stripe. Thus, it is possible to transmit illuminating light into one light guide stripe and detect light delivered out of another light guide stripe, the light guide stripes being connected via said kind of coupling arrangement. Increased power of the detected light indicates the presence of an external object within the restricted interaction area. In a preferred embodiment, the first and the second light guide stripes are directed at an angle, preferably substantially perpendicularly, with respect to each other. By this way it is possible to implement, for example, a grid of two intersecting arrays of light guide stripes with a restricted interaction areas defined at the intersections of the light guide stripes. The first and the second light guide stripes can be located in different layers within the light guide assembly. In some applications, it is possible also to have them in the same plane as a single light guide grid where, at the intersections, the light guide stripes are united.

In the above embodiments relying on two-way coupling arrangements, there are various alternatives to implement the actual coupling arrangements. In one embodiment, the coupling arrangement comprises at least one inclined reflective surface configured to couple light between the light guide assembly and the ambient by means of reflection from said surface. “Inclined” means here inclined with respect to the plane in which the light guide assembly is extended or, in the case of a curved, non-planar light guide assembly, the tangential plane of thereof. In other words, when light propagating in the light guide assembly meets a properly inclined, at least partly reflecting surface, it is reflected in a direction in which it escapes the light guide assembly. Respectively, a similar reflective surface can also reflect the light reflected from the external object in a direction in which it can again propagate within the light guide assembly e.g. via total internal reflections.

As one simple example of such reflecting inclined surfaces, a light guide stripe may be interrupted by a wedge-shaped prism or micro-prism, the one side of the prism serving for out-coupling and the other for in-coupling. The area outside the light guide assembly above the prism, from which area the initially out-coupled light can be reflected back to be in-coupled into the light guide stripe again, is the restricted interaction area.

Various forms of reflective surfaces and prism and arrays thereof can be used to implement the reflection-based coupling arrangements. In some designs, the same inclined surface(s) can serve for both out-coupling and in-coupling.

In addition to, or as alternatives for the reflective coupling elements, the coupling arrangement can also comprise at least one grating, for example a diffractive grating, configured to couple light between the light guide assembly and the ambient. Especially diffractive gratings provide effective and versatile means for controlling the out-coupling and in-coupling of light.

According to a second aspect, the present invention is also focused on a touch sensing device having a touch sensitive area. The touch sensing device comprises a light guide assembly as defined above located in the touch sensitive area. By optical touch sensing device is meant here a complete, operable device which may comprise, in addition to the light guide assembly, also the light sources and detectors as well as appropriate electrical control means.

In one embodiment, the touch sensing device further comprises a transmitter system configured to transmit light signals to a plurality of first light guide stripes; and a receiver system configured to receive light signals delivered out of a plurality of second light guide stripes. The transmitter and receiver systems can be implemented by using components, e.g. light sources such as LEDs or lasers and detectors, as well as signal processing elements, which are, as such, known in the art.

In one preferred approach, the transmitter system is configured to modulate the signal transmitted to each first light guide stripe differently from the signals transmitted to the other first light guide stripes; and the receiver system is configured to identify the related first light guide stripe of each received light signal on the basis of said modulation. In other words, signal(s) sent to each first light guide stripe of the plurality of the first light guide stripes is/are individualized by the modulation so that based on the modulation, it can be resolved to which first light guide stripe the finally received light signal delivered out of the light guide stripe was transmitted. This way, the location of the interaction area, in which the interaction took place, can be determined. For example, in a two-dimensional array of intersecting first and second light guide stripes, there may be a plurality of intersections with the first light guide stripes and thus a plurality of restricted interaction areas along each single second light guide stripe. Modulation allows identification of the first light guide stripe from which the received light signal is originated.

In one embodiment, the modulation is based on transmitting the light signals to the first light guide stripes simply at different times. The modulation can also be based on frequency modulation or different waveforms of the transmitted light signals. In a bit more complex approach, the modulation is based on code division multiple access modulation (CDMA) of the transmitted light signals. Each of those modulation schemes can also be used in combination with one or more of the other modulation schemes.

As an alternative, or in addition to the actual modulation approaches above, in one embodiment, the transmitter system is configured to transmit the signal to each first light guide stripe at a wavelength different from the wavelengths of the signals transmitted to the other first light guide stripes; and the receiver system is configured to identify the related first light guide stripe of each received light signal on the basis of the wavelength of the received signal.

In addition to just one light guide assembly, it is also possible to have multiple light guide assemblies as described above, e.g. arranged in an array, to cover a large touch sensitive area of a touch sensing device. Thus, instead of forming a very large light guide assembly that might be challenging to manufacture, it is possible to use multiple smaller assemblies to cover such large touch sensitive area.

According to a third aspect, the present invention is also focused on a touch screen comprising a display and an optical touch sensing device as defined above. The type and the details of the display as well as the touch sensing device and the integration thereof can be arranged according to the principles and practices known in the art. The display can be e.g. an liquid crystal display (LCD) or an organic LED display (OLED). The light guide assembly of the touch sensing device can be placed in front of the display. It can alternatively be placed also behind the display, provided that the display unit is sufficiently transparent in the wavelength range that is used by the light guide assembly.

According to a fourth aspect, the present invention is further focused on a method for detecting a touch. According to the present invention, an optical touch sensing device as defined above is used in the method. The method comprises the steps of receiving light delivered further out of the light guide assembly of the touch sensing device; and detecting the presence of an external object on the touch sensitive area of the touch sensing device or in the vicinity thereof on the basis of changes in the thereby received light due to interaction of the light with the external object.

### BRIEF DESCRIPTION OF FIGURES

Various embodiments of the present invention are described in the following with reference to the accompanying schematic drawings (presented not in scale), wherein

FIG. 1 illustrates a configuration of a touch sensing device;

FIGS. 2a and 2b illustrate details of a light guide assembly; and

FIGS. 3a and 3b illustrate coupling elements and coupling arrangements for use in an interaction arrangement of a light guide assembly.

In the drawings, the corresponding elements of different embodiments are marked with the same reference numbers. The propagation of light in the presented structures is generally marked with arrows.

### DETAILED DESCRIPTION

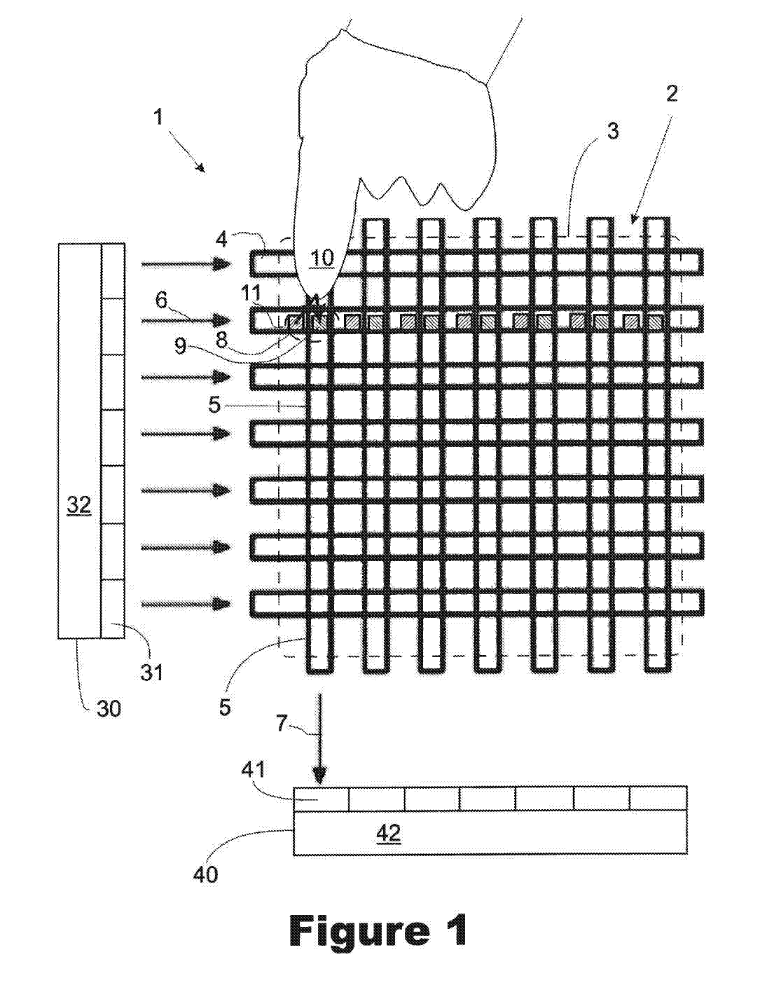

FIG. 1 illustrates a part of a touch sensing device comprising a light guide assembly 2 arranged in a touch sensitive area 3 of the touch sensing device.

The light guide assembly 2 of FIG. 1 comprises two perpendicularly arranged arrays of light guide stripes 4, 5. The light guide stripes 4 of one of the arrays are designed for receiving illumination light 6, whereas the light guide stripes 5 of the other array are designed for delivering the light 7 propagated in the light guide assembly further out of the light guide assembly, as indicated by arrows marked in the drawing. Preferably, the illumination light lies in the infrared portion of the spectrum so that interference with the visible wavelengths emitted by the display of a touch screen or present in the ambient is minimized.

The light guide stripes 4, 5 of FIG. 1, as well as also the light guide stripes in the examples of the other Figures, can be designed and manufactured according to the principles and practices known in the art. For example, the light guide stripes can have a circular, elliptical, or rectangular cross-section and they can be made of some plastic light guide materials, e.g. PMMA (Polymethyl methacrylate) or PET (Polyethylene terephthalate). On the other hand, silicon dioxide SiO₂, titanium dioxide TiO₂, and silicon nitride Si₃O₄ are examples or harder materials as an alternative to plastics. Also glass can be used as a material of the light guides. For example, glass light guides may be formed with ion-exchange diffusion. The dimensions of the light guide stripes can be adjusted e.g. according to the desired resolution performance of the touch sensing device. The light guide stripes can be configured for single mode or multi-mode light wave propagation. For example, in single-mode wave guides, the width of a stripe can be about 10 μm or less. In multi-mode light guides, the typical width is 50μm or higher, it can lie also in the millimeter scale. In particular in the embodiments with two-way coupling arrangements, the width of the in-coupling element should be sufficiently large to ensure sufficient in-coupling of light, which can affect the requirements for width of the light guide stripe.

Plastic light guide stripes can be manufactured e.g. by using nanoimprint lithography NIL. For the harder materials, one possibility for manufacturing is formed by various thin film and pholitographic processes.

In the example of FIG. 1, the two arrays of light guide stripes are arranged in different layers in a touch sensing device assembly. Alternatively, they could also be arranged as a light guide grid within a single layer so that at the intersections, the light guide stripes of the perpendicular arrays would be combined.

The light guide assembly 2 of FIG. 1 comprises two-way coupling arrangements with out-coupling elements 8 for coupling part of the illumination light out of the light guide stripes, and in-coupling elements 9 for coupling the part of this out-coupled light, as reflected from an external object, such as the fingertip 10 illustrated in the drawing of FIG. 1, back to the light guide assembly 2. The coupling elements 8, 9 are located close to the intersections of the light guide stripes of the two arrays. The out-coupling elements 8 lie on the light guide stripes 4 for receiving the illumination light 6 (the horizontal light guide stripes in the drawing), and the in-coupling elements 8 lie on the (vertical) light guide stripes 5 for delivering the light 7 further out of the light guide assembly.

Each pair of out-coupling and in-coupling elements can be considered as an interaction arrangement defining a restricted area of interaction 11, i.e. an area on the touch sensing region within which an external object can cause the light propagating via the light guide assembly to interact with the external object. In other words, an external object lying too far from a pair of an out-coupling and an in-coupling grating cannot cause such interaction. Such interaction, in turn, causes a detectable change in the light 7 delivered further out of the light guide assembly via the associated vertical light guide stripe 5.

For the sake of clarity, only the pairs of out-coupling and in-coupling elements 8, 9 corresponding one of the horizontal light guide stripes 4 is illustrated in FIG. 1. However, in reality, each of the horizontal light guide stripes may comprise an out-coupling element at each intersection with a vertical light guide stripe 5. The out-coupling elements of a light guide stripe are preferably configured so that each of the out-coupling elements couples a similar proportion of the received illumination light 6 out of the light guide stripe.

From the operational point of view, a touch of an external object on, or the presence of such in the proximity of the touch sensitive area 3, causes an increase in the light power delivered out of the vertical light guide stripe(s) corresponding to the location of the external object. The vertical location of the touch can be determined, for example, by illuminating one horizontal light guide stripe 4 at a time. The horizontal direction is not as straightforward to determine; when the out-coupled light hits an external object, it is reflected to various directions, not just downwards. As a consequence of this, the reflected light may be coupled into several vertical light guide stripes. However, the in-coupling is typically most effective via the in-coupling elements lying closest to the location of the touching external object, thereby allowing proper determination of the position of the touch. By comparing the relative strengths of reflections between vertical light guide stripes it is possible to interpolate the location of the reflecting object with resolution that is better than the distance between the stripes, giving sub-stripe accuracy.

The touch sensing devices 1 of FIG. 1 comprises further a transmitter system 30 and a receiver system 40 for transmitting light signals 6 to the first light guide stripes 4 and for receiving light signals 7 delivered out of the second light guide stripes, respectively. The transmitter system 30 comprises a plurality of light sources 31, e.g. light emitting diodes LEDs, driven and controlled by a signal processing and control unit 32. Respectively, the light receiving unit 40 comprises a plurality of light detectors 41 coupled to a detecting unit 42 having appropriate electronics for receiving and processing the received signals. Naturally, the transmitter and receiver systems may also comprise any appropriate further electronic, optical, or mechanical means required to implement the light signal transmitting and receiving functions.

The transmitter system is configured to individualize the signals transmitted to the first light guide stripes so that when a light signal at least partially coupled back to the light guide assembly is delivered out of a second light guide stripe, the first light guide stripe from which the light signal was initially coupled out can be determined by the receiver system 40 on the basis of said individualization. Consequently, also the location of the restricted area of interaction 11 within which the reflection of light from the external object 10 caused the coupling of the initially out-coupled light signal back to the light guide assembly, can be determined. This way, the location of touch can be found out.

The individualization of the transmitted signals can be based on various modulation principles, wherein the signal transmitted to each first light guide stripe 4 is modulated differently from the signals transmitted to the other first light guide stripes. For example, the modulation can be based on frequency modulation of the transmitted light signals or on different wave-forms of the transmitted signals. Also code division multiple access modulation (CDMA) can be used. As mentioned above, the signals can also be transmitted to the different first light guide stripes simply at different times. The different signals can also be transmitted at different wavelengths, in which case the receiver system naturally has to be capable of determining the wavelength of the received signal 7.

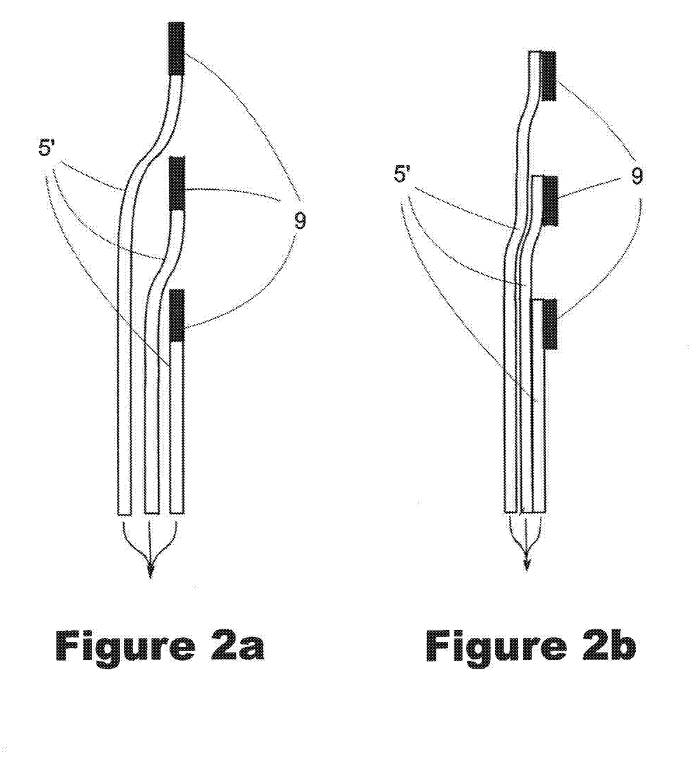

FIGS. 2a and 2b illustrate alternatives to the continuous vertical light guide stripes of FIG. 1. In the approach of FIGS. 2a and 2b, each in-coupling element 9 of one vertical “line” is coupled to an own light guide sub-stripe 5′. This eliminates the possibility for out-coupling of light, already coupled in a vertical light guide stripe via one of its in-coupling elements, via another in-coupling element thereof. The separate light guide sub-stripes may be connected out-side the touch sensitive area, wherein the determination of the vertical location of a touch can be based on row-by-row illumination scheme, i.e. transmitting illumination light into only one horizontal light guide stripe at a time.

The coupling elements 8, 9 in the light guide assemblies above comprise diffractive optical gratings. Diffractive optics provides an efficient and versatile way to design and manufacture coupling elements with various coupling characteristics. Diffractive gratings may be designed and manufactured according to the principles known in the art, so no detailed explanation thereof is given here. As an example, diffractive gratings with a blazed grating profile or a binary slanted grating profile may be used.

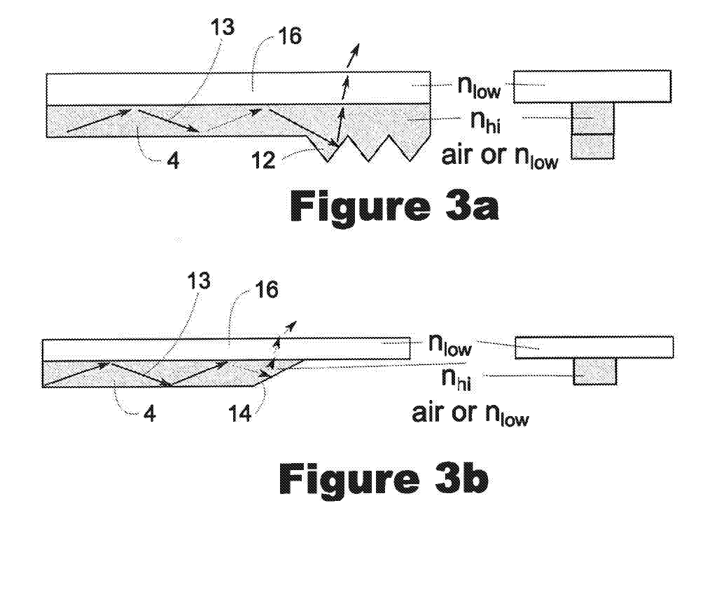

As alternatives to diffractive gratings, the coupling elements may also be based on more simple reflective surfaces arranged in the light guide assembly. FIG. 3a shows schematically, as a longitudinal section and a cross section, an array of microprisms 12 on a surface of a light guide stripe 4, configured to couple a part of the light 13 propagating in the light guide stripe out of it. FIG. 3b shows as another example, wherein a light guide stripe simply ends with an inclined facet 14 which reflects part of the light 13 propagating in the light guide stripe and incident on the inclined facet out of the light guide stripe. Similar structures can be used also as in-coupling elements configured to couple a part of the out-coupled light, after reflection from e.g. a fingertip, back to the light guide assembly. In both of the examples of FIGS. 3a and 3b, the light guide structure comprises a low refractive index (“n_{low},”) cladding layer 16 on the actual higher refractive index (“nₕᵢ”) light guide stripe for protecting the latter and ensuring proper conditions for total internal reflections at the surface thereof.

In the embodiments of FIGS. 1 to 3, the operation of the touch sensing device is thus based on reflection of part of the initially out-coupled light back to the light guide assembly. This kind of interaction between the light and the external object does not necessitate a true physical contact between the touching external object and the touch sensing device. Sufficient reflection may be achievable also by an external object brought into sufficiently close proximity of the touch sensing device. The size and the structural and material details of the coupling arrangement define a restricted interaction area 11 within which an external object 10, sufficiently close to the light guide, can cause detectable interaction between the light and the external object.

It is important to note that the above examples are for illustrative purposes only, without limiting the scope of the invention. The embodiments of the present invention may freely vary within the scope of the claims.

1. A light guide assembly for use in a touch sensitive area of an optical touch sensing device for touch screens, the light guide assembly being configured to receive light, to allow the light thereby received to propagate in the light guide assembly, and to deliver the light thereby propagated in the light guide assembly further out of the light guide assembly, the light guide assembly comprising a plurality of light guide stripes for controlling the propagation of light in the light guide assembly; the optical touch sensing device being configured to detect the presence of an external object on the basis of changes in the light delivered further out of the light guide assembly due to interaction of the light with the external object, wherein the light guide assembly comprises an interaction arrangement configured to define at least one restricted interaction area within the touch sensitive area for interaction between the light and the external object, the interaction arrangement comprising a two-way coupling arrangement configured to couple light out of the light guide assembly, out of one light guide stripe, and to couple a portion of the thereby out-coupled light, after reflection from the external object, back to the light guide assembly into a second light guide stripe, for detecting the presence of the external object on the basis of said reflection; wherein the first and the second light guide stripes are directed at an angle.

2. A light guide assembly as defined in claim 1, wherein the coupling arrangement comprises at least one inclined reflective surface configured to couple light between the light guide assembly and the ambient by means of reflection.

3. A light guide assembly as defined in claim 1, wherein the coupling arrangement comprises at least one grating, configured to couple light between the light guide assembly and the ambient.

4. An optical touch sensing device having a touch sensitive area, wherein the touch sensing device comprises a light guide assembly as defined in claim 1 located in the touch sensitive area.

5. An optical touch sensing device as defined in claim 4, further comprising
a transmitter system configured to transmit light signals to a plurality of first light guide stripes; and
a receiver system configured to receive light signals delivered out of a plurality of second light guide stripes.

6. An optical touch sensing device as defined in claim 5, wherein
the transmitter system is configured to modulate the signal transmitted to each first light guide stripe differently from the signals transmitted to the other first light guide stripes; and
the receiver system is configured to identify the related first light guide stripe of each received light signal on the basis of said modulation.

7. An optical touch sensing device as defined in claim 6, wherein the modulation is based on transmitting the light signals to the first light guide stripes at different times.

8. An optical touch sensing device as defined in claim 6, wherein the modulation is based on frequency modulation of the transmitted light signals.

9. An optical touch sensing device as defined in claim 6, wherein the modulation is based on different waveforms of the transmitted light signals.

10. An optical touch sensing device as defined in claim 6, wherein the modulation is based on code division multiple access modulation of the transmitted light signals.

11. An optical touch sensing device as defined in claim 5, wherein
the transmitter system is configured to transmit the signal to each first light guide stripe at a wavelength different from the wave-lengths of the signals transmitted to the other first light guide stripes; and
the receiver system is configured to identify the related first light guide stripe of each received light signal on the basis of the wavelength of the received signal.

12. A touch screen comprising a display and an optical touch sensing device as defined in claim 4.

13. A method for detecting a touch using an optical touch sensing device as defined in claim 4, the method comprising the steps of
receiving light delivered further out of the light guide assembly of the touch sensing device, and
detecting the presence of an external object on the basis of changes in the thereby received light due to interaction of the light with the external object.

14. A light guide assembly as defined in claim 1, wherein the first and second light guide stripes are directed at a substantially perpendicular angle with respect to each other.

15. A light guide assembly as defined in claim 3, wherein the coupling arrangement comprises a diffractive grating.
